(19) United States
(12) Patent Application Publication
(10) Pub. No.: US 2026/0328369 A1
(43) Pub. Date: Oct. 22, 2026

(54) ILLUMINATION MODULE

(71) Applicants: OPPLE LIGHTING CO., LTD., Shanghai (CN); SUZHOU OPPLE LIGHTING CO., LTD., Suzhou City (CN)

(72) Inventor: Quanbiao WANG, Shanghai (CN)

(73) Assignees: OPPLE LIGHTING CO., LTD., Shanghai (CN); SUZHOU OPPLE LIGHTING CO., LTD., Suzhou City (CN)

(21) Appl. No.: 19/724,844

(22) Filed: Jun. 29, 2026

Related U.S. Application Data
(63) Continuation of application No. PCT/CN2024/143243, filed on Dec. 27, 2024.

(30) Foreign Application Priority Data
Dec. 31, 2023 (CN) 202323667869.5

(51) Int. Cl. F21V 15/01; F21V 17/16; F21V 19/00; F21V 23/00

(52) U.S. Cl. CPC F21V 15/01; F21V 17/16; F21V 19/0045; F21V 23/001

(57) ABSTRACT

An illumination module includes a housing and a light source module. The housing includes a first housing and a second housing snap-fitted together to define a mounting cavity. The first housing includes a mounting wall having a wire-passing groove. The light source module is disposed in the mounting cavity and includes a built-in light source assembly, an insulating housing, and a first power line electrically connected to the built-in light source assembly. The insulating housing is disposed between the built-in light source assembly and the first housing and includes an accommodating groove for accommodating the built-in light source assembly and a first wire-fixing cavity configured to receive the first power line.

### CROSS-REFERENCE TO RELATED DISCLOSURES

This disclosure is based upon and claims the priority of PCT patent disclosure No. PCT/CN2024/143243 filed on Dec. 27, 2024, which claims priority to the Chinese patent disclosure No. 202323667869.5 filed on Dec. 31, 2023, the entire contents of which are hereby incorporated by reference herein for all purposes.

### TECHNICAL FIELD

The present disclosure relates to an illumination module, belonging to the technical field of lighting.

### BACKGROUND

In an illumination module, the power line may be exposed on the outer side or directly pass through a housing to be connected to mains power.

### SUMMARY

The present disclosure provides an illumination module including a housing and a light source module.

Accordingly, the insulating housing may include an accommodating groove configured to accommodate the built-in light source assembly and a first wire-fixing cavity configured to receive the first power line. The first wire-fixing cavity is receivable in the wire-passing groove such that the first power line extends through the first wire-fixing cavity and the wire-passing groove.

In some examples, the housing and the insulating housing include cooperating fool-proof structures and positioning structures to facilitate installation of the light source module. The housing may further include a mounting hole configured to receive a fastener for mounting an external light source assembly.

It is to be understood that both the foregoing general description and the following detailed description are exemplary and explanatory only and are not restrictive of the present disclosure.

### BRIEF DESCRIPTION OF DRAWINGS

FIG. 1 is a schematic structural diagram of a first example of an illumination module according to the present disclosure.

FIG. 2 is an exploded view of the illumination module of FIG. 1.

FIG. 3 is a schematic cross-sectional view of the illumination module of FIG. 1.

FIG. 4 is a schematic cross-sectional view of a portion of structure of the illumination module of FIG. 1.

FIG. 5 is a schematic structural diagram of a first housing in FIG. 1.

FIG. 6 is a schematic structural diagram of a second housing in FIG. 1.

FIG. 7 is a schematic structural diagram of the second housing of FIG. 6 from another perspective.

FIG. 8 is a schematic structural diagram of an insulating housing in FIG. 2.

FIG. 9 is an exploded view of a lens assembly in FIG. 2.

FIG. 10 is a schematic structural diagram of a second example of an illumination module according to the present disclosure.

FIG. 11 is an exploded view of the illumination module of FIG. 10.

FIG. 12 is a schematic cross-sectional view of the illumination module of FIG. 10.

FIG. 13 is a schematic structural diagram of an external light source assembly in FIG. 11.

FIG. 14 is a schematic structural diagram of an insulating member in FIG. 11.

FIG. 15 is a schematic structural diagram of a micro-prism reflector in FIG. 11.

### DETAILED DESCRIPTION OF EXAMPLES

To make the objectives, technical solutions and advantages of the present disclosure clearer, the present disclosure is described in detail below with reference to the drawings and examples.

It should be noted herein that, in order to avoid obscuring the present disclosure with unnecessary details, the drawings show only the structures and/or processing steps closely related to the solutions of the present disclosure, while omitting other details that are not closely related to the present disclosure.

In addition, it should also be noted that the terms "comprising", "including" or any other variation thereof are intended to cover non-exclusive inclusion, such that a process, method, article or apparatus that comprises a series of elements not only comprises those elements, but also comprises other elements not expressly listed, or further comprises inherent elements of such process, method, article or apparatus.

Description of reference numerals may include:
Lighting module 100;
Housing 10,
first housing 11,
mounting wall 111,
first fool-proof part 113,
wire-passing groove 114,
first positioning member 115,
first mounting hole 116,
connecting wall 112,
first snap-fit part 1121,
relief groove 1122,
first abutting part 1123,
second housing 12,
base 121,
carrying part 122,
second extension wall 1221,
carrying wall 1222,
first positioning snap-fit part 1223,
first extension wall 123,
second snap-fit part 1231,
snap-fit protrusion 1232,
guide surface 1233,
snap-fit surface 1234,
inclined end surface 1235,
force-relieving groove 1236,
inclined surface 1237,
second abutting part 1238,
lip 124,
mounting rotating shaft 125,
mounting cavity 13,
receiving space 131,
third housing 14,
rotating shaft groove 141,
face ring 15,
torsion spring 16,
light outlet 17;
Light source module 20,
built-in light source module 21,
built-in light source assembly 211,
insulating housing 212,
top wall 2121,
first wire-fixing cavity 2122,
second fool-proof part 2123,
peripheral wall 2124,
first power line 213,
external light source module 22,
external light source assembly 221,
light source bracket 222,
mounting part 2221,
outer edge part 2222,
second wire-fixing cavity 2223,
third fool-proof part 2224,
second mounting hole 2225,
second power line 223,
insulating member 224,
relief hole 2241,
relief groove 2242,
relief notch 2243,
second positioning member 225;
Optical module 30,
first end 31,
second end 32,
second positioning snap-fit part 321,
side wall 33,
lens assembly 34,
lens 341,
lens bracket 342,
micro-prism reflector 35.

During the installation process, the power line may be easily pulled and damaged, which affects the service life of the illumination module. In view of this, it is indeed necessary to provide an illumination module to solve the above problems.

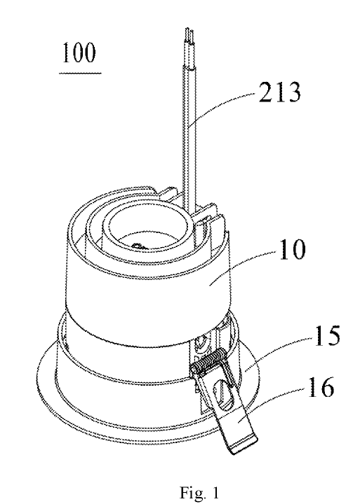

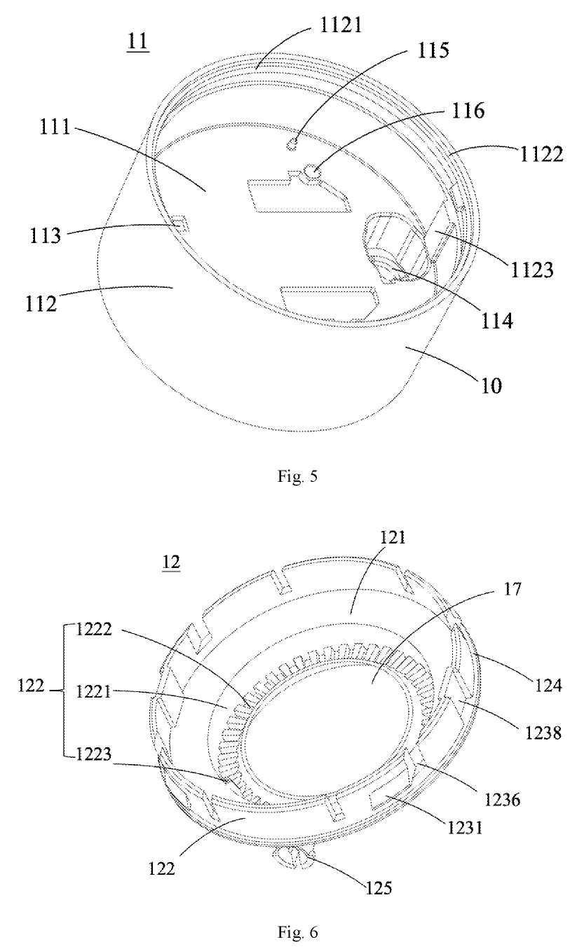

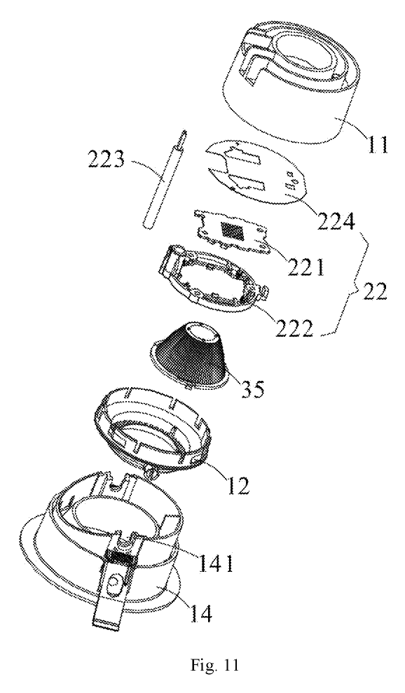

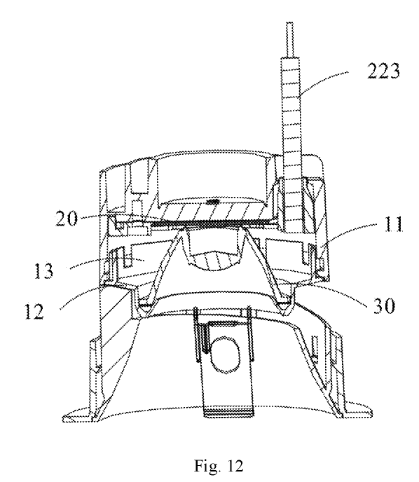

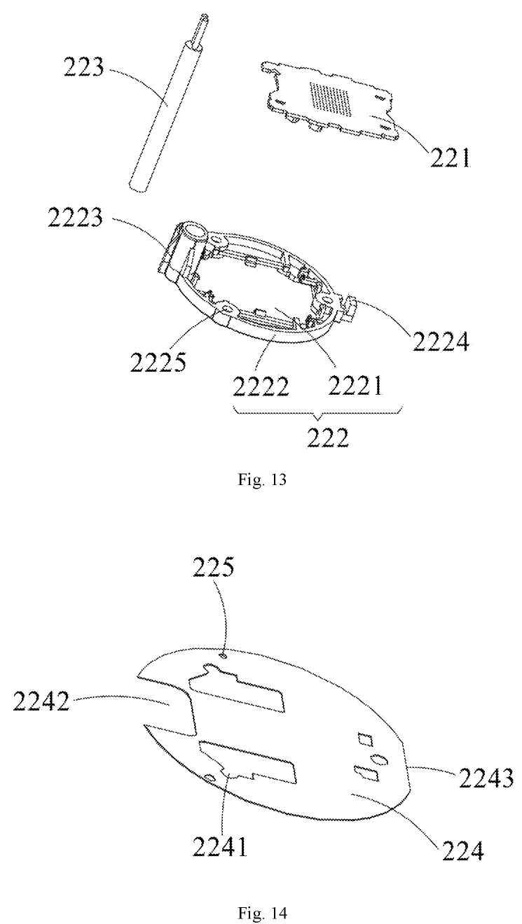

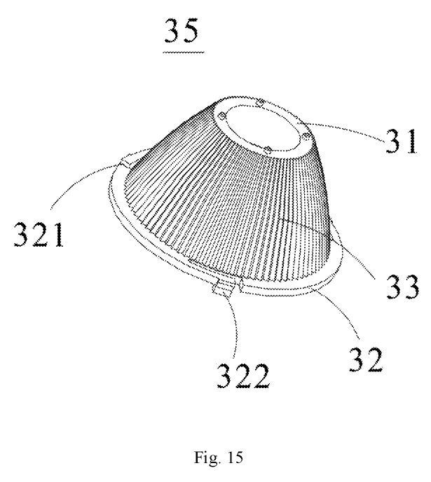

Referring to FIGS. 1-15, the present disclosure provides an illumination module 100. The illumination module 100 includes a housing 10, a light source module 20 and an optical module 30. The housing 10 includes a first housing 11 and a second housing 12, a mounting cavity 13 is provided between the first housing 11 and the second housing 12, the light source module 20 is disposed in the mounting cavity 13 and abuts against the first housing 11, and the optical module 30 is disposed in the mounting cavity 13 and located between the light source module 20 and the second housing 12.

Optionally, the light source module 20 may be any one of a built-in light source module 21 or an external light source module 22. The first housing 11 is provided with a first mounting structure and a second mounting structure. The built-in light source module 21 is mounted to match the first mounting structure, and the external light source module 22 is mounted to match the second mounting structure. By providing the first mounting structure and the second mounting structure in the first housing 11, wherein the first mounting structure is adapted for mounting the built-in light source module 21 and the second mounting structure is adapted for mounting the external light source module 22, the function of one housing 10 matching different light source modules 20 is achieved, which solves the problem of the existing illumination module 100 being single, and different mounting structures may be matched according to different light source modules 20, so that one lamp has multiple uses and different customized requirements are satisfied.

Further, the first mounting structure and the second mounting structure have the same structural parts. That is, some structural parts in the first mounting structure are the same as some structural parts in the second mounting structure. With such an arrangement, different light source modules 20 are mounted and snapped together by means of some common structural parts, so that structural design on the first housing 11 can be reduced, the structure of the first housing 11 is simplified, processes are reduced, and costs are saved, while one lamp still has multiple uses.

Optionally, the second mounting structure includes the first mounting structure and further has structural parts different from those of the first mounting structure. That is, the second mounting structure has the same structural parts as the first mounting structure and some unique structural parts for connecting to the external light source module 22. With such an arrangement, different light source modules 20 can be adapted on the premise of saving costs, so as to improve the applicable scope of the housing 10 of the illumination module 100.

Optionally, the optical module 30 may be any one of a micro-prism reflector 35 and a lens assembly 34, or the optical module 30 may be a structure of other forms, which is not specifically limited. The second housing 12 is also provided with a carrying part 122 matching the optical module 30. By providing the carrying part 122 on the second housing 12 to match a plurality of optical modules 30, different optical elements may be selected according to different lighting requirements, so that one lamp has multiple uses.

In order to clearly illustrate the structure of the illumination module 100 of the present disclosure, the following specification describes some examples by way of example, but it should be understood by those skilled in the art that the present disclosure is not limited thereto.

Referring to FIGS. 1-9, a first example of the illumination module 100 of the present disclosure is shown. In this example, the illumination module 100 includes a housing 10, a light source module 20 and an optical module 30. The light source module 20 is a built-in light source module 21, and the optical module 30 is a lens assembly 34.

The housing 10 includes a first housing 11, a second housing 12 and a third housing 14. The second housing 12 is disposed between the first housing 11 and the third housing 14, and is connected to the first housing 11 and the third housing 14 respectively. The first housing 11 is snap-connected to the second housing 12, and a mounting cavity 13 for mounting the light source module 20 and the optical module 30 is formed between the first housing 11 and the second housing 12. The third housing 14 is used for connecting to a mounting base, and the third housing 14 is rotatably connected to the second housing 12. By rotating the second housing 12, the first housing 11 is driven to rotate synchronously, so that the lighting direction of the illumination module 100 can be changed.

The first housing 11 includes a mounting wall 111 and a connecting wall 112 extending from the mounting wall 111 toward the second housing 12. The mounting wall 111 is used for mounting and connecting with the light source module 20, and the connecting wall 112 is used for snap-fit mounting with the second housing 12.

The first mounting structure includes a first fool-proof part 113 and a wire-passing groove 114 which are provided on the mounting wall 111. The first fool-proof part 113 is used for positioning and snapping with an insulating housing 212 in the built-in light source module 21. The wire-passing groove 114 is used for snapping with a first power line 213 in the built-in light source module 21, and allows the first power line 213 to pass through to be connected to external mains power.

In this example, the first fool-proof part 113 is a clamp groove recessed from the mounting wall 111 in a direction away from the mounting cavity 13. Certainly, in other examples, the first fool-proof part 113 may be a protrusion extending from the mounting wall 111 into the mounting cavity 13, which is not limited herein.

The wire-passing groove 114 is disposed at one end opposite the clamp groove, and is recessed from the mounting wall 111 in the direction away from the mounting cavity 13. The wire-passing groove 114 includes a first opening facing the mounting cavity 13 and a second opening facing away from the mounting cavity 13. The area of the first opening is larger than the area of the second opening. With such an arrangement, a first wire-fixing cavity 2122 snapped with the first power line 213 can enter the wire-passing groove 114 through the first opening, but is limited by the second opening.

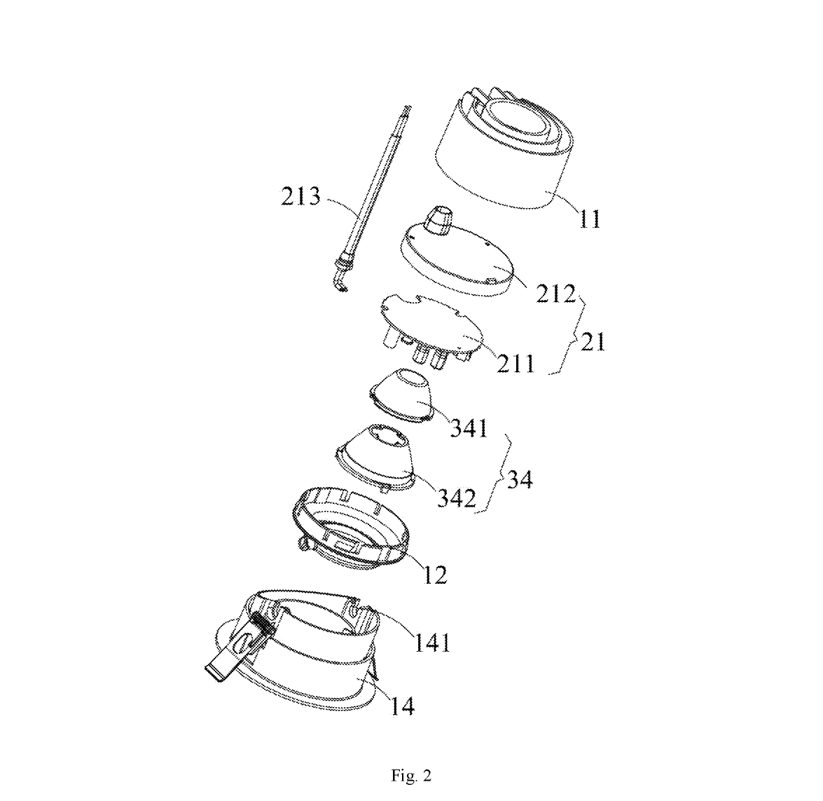

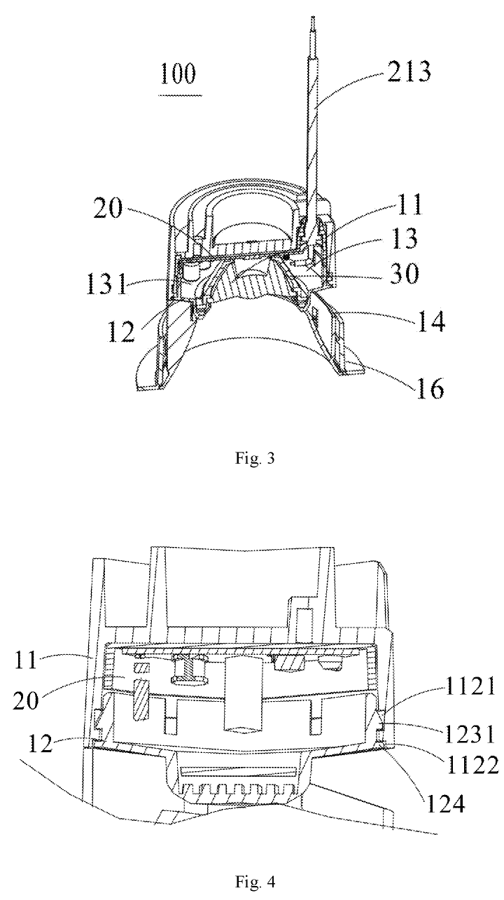

Referring to FIG. 8 in combination with FIGS. 2 and 3, the built-in light source module 21 includes a built-in light source assembly 211, an insulating housing 212 and a first power line 213. The insulating housing 212 is disposed between the built-in light source assembly 211 and the first housing 11. The built-in light source assembly 211 is electrically connected to the first power line 213, and the connected built-in light source assembly 211 is located on a side of the insulating housing 212 facing away from the mounting wall 111. Preferably, the built-in light source assembly 211 is a non-insulated light source assembly. By disposing the insulating housing 212 between the built-in light source assembly 211 and the first housing 11, safety of the illumination module 100 is improved.

In this example, the built-in light source assembly 211 is an integrated DOB (Driver On Board) light source component, including a first power board and a light-emitting component disposed on the first power board and a non-light-emitting component surrounding the light-emitting component. The non-light-emitting component is an electrical element or the like. The first power line 213 is electrically connected to the first power board.

The insulating housing 212 includes a top wall 2121 facing the mounting wall 111 and a peripheral wall 2124 extending from the top wall 2121 in the direction away from the mounting wall 111. An accommodating groove for accommodating the built-in light source assembly 211 is formed between the top wall 2121 and the peripheral wall 2124. A positioning protrusion for positioning and connecting with the built-in light source assembly 211 is provided in the accommodating groove.

At a side of the top wall 2121 facing away from the accommodating groove (i.e., a side facing away from the built-in light source assembly 211), a second fool-proof part 2123 snapped with the first fool-proof part 113 and a first wire-fixing cavity 2122 snapped with the wire-passing groove 114 are provided.

In this example, the second fool-proof part 2123 is a protrusion extending from the top wall 2121 in the direction away from the accommodating groove. The protrusion is snapped with the clamp groove, so as to achieve fool-proof of the built-in light source module 21 and the first housing 11. Certainly, in other examples, the second fool-proof part 2123 may be a clamp groove recessed from the top wall 2121 toward the accommodating groove, which is not limited herein.

The first wire-fixing cavity 2122 is formed by extending from a side of the top wall 2121 facing away from the accommodating groove toward the first housing 11, and allows the first power line 213 to pass through and snaps the first power line 213 therein. The position of the first wire-fixing cavity 2122 corresponds to the wire-passing groove 114, and the first wire-fixing cavity 2122 can be mounted in the wire-passing groove 114 by snap-fit.

The first wire-fixing cavity 2122 is provided therein with a snap-fit protrusion snapped with the first power line 213. The first power line 213 is provided with a snap-fit groove. The snap-fit protrusion is snapped in the snap-fit groove, so as to fix and snap the first power line 213 in the first wire-fixing cavity 2122, and the first power line 213 is at least partially received in the first wire-fixing cavity 2122. The first power line 213 is snapped with the wire-passing groove 114 through the first wire-fixing cavity 2122, and the first power line 213 is configured to sequentially pass through the first wire-fixing cavity 2122 and the wire-passing groove 114 to be connected to mains power. By providing the first wire-fixing cavity 2122 on the insulating housing 212, the first power line 213 is at least partially received in the first wire-fixing cavity 2122 and snapped with the first wire-fixing cavity 2122, and then the entire first wire-fixing cavity 2122 is received in the wire-passing groove 114, so as to fix the first power line 213 and provide double protection, thereby preventing the first power line 213 from being pulled and damaged, and improving the service life of the illumination module 100.

Optionally, in order to increase the mounting and positioning of the built-in light source module 21 and the first housing 11, the first housing 11 is further provided with a first positioning member 115, and the insulating housing 212 of the built-in light source module 21 is correspondingly provided with a second positioning member 225.

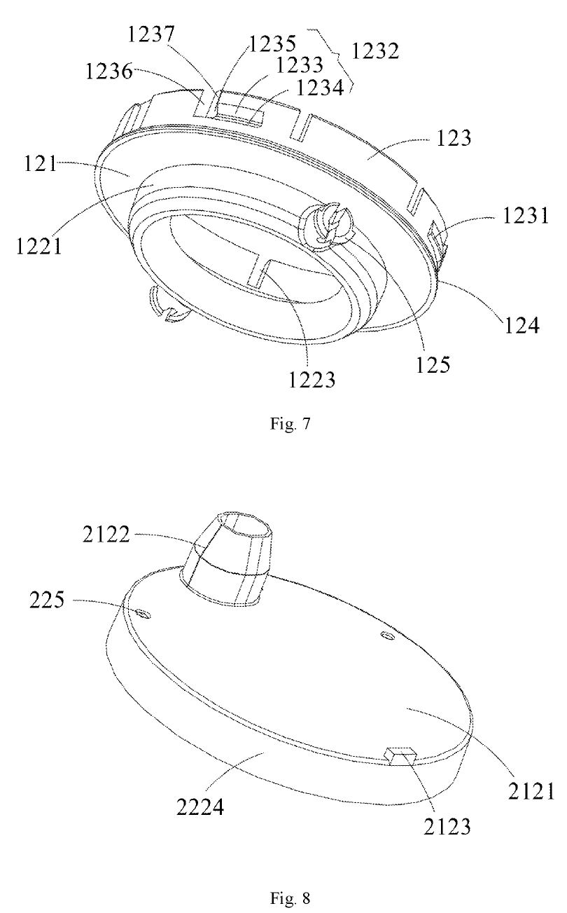

Please continue to refer to FIGS. 3 and 7, in this example, the mounting wall 111 is further provided with a first positioning member 115. The first positioning member 115 is a positioning post extending from the mounting wall 111 into the mounting cavity 13. The top wall 2121 of the insulating housing 212 is provided with a second positioning member 225. The second positioning member 225 is a positioning hole. The positioning post is snapped in the positioning hole, so as to achieve positioning connection between the mounting wall 111 and the insulating housing 212. In other examples, the first positioning member 115 may also be a positioning hole provided on the mounting wall 111, and the second positioning member may be a positioning post extending from the top wall 2121 toward the mounting wall 111.

Optionally, a plurality of positioning posts may be provided, for example, two positioning posts respectively disposed on two sides of the mounting wall 111 and located at positions different from the first fool-proof part 113 and the wire-passing groove 114. Similarly, a plurality of positioning holes are also provided, and the positions of the plurality of positioning holes match the positions of the plurality of positioning posts.

After the built-in light source module 21 is connected to the mounting wall 111 of the first housing 11 through the first mounting structure, one end of the optical module 30 abuts against the built-in light source module 21, and the other end is snapped with the second housing 12.

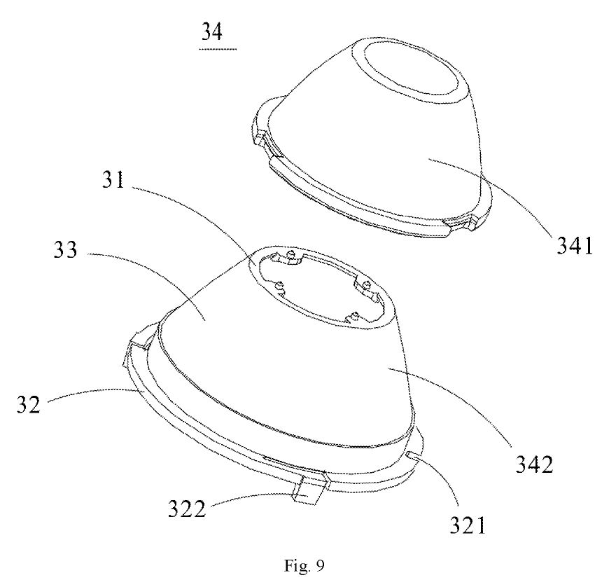

Referring to FIG. 9 in combination with FIGS. 2 and 3, in this example, the optical module 30 is a lens assembly 34 (for example, a TIR lens 341). The lens assembly 34 includes a lens 341 and a lens bracket 342. The interior of the lens bracket 342 is provided with a mounting position for mounting the lens 341. A first end 31 and a second end 32 of the lens bracket 342 respectively abut against the optical module 30 and the second housing 12.

The lens bracket 342 includes a first end 31, a second end 32, and a side wall 33 connecting the first end 31 and the second end 32. The side wall 33, the first end 31 and the second end 32 jointly enclose to form the mounting position for mounting the lens 341. The diameter of the first end 31 is smaller than the diameter of the second end 32. A small-diameter end of the lens 341 is connected to the first end 31, and a large-diameter end of the lens 341 is connected to the second end 32.

The first end 31 is provided with an abutting part extending toward the built-in light source assembly 211. Four abutting parts abut against the outer side of the light-emitting component of the built-in light source assembly 211, so that the first end 31 covers the outer side of the light-emitting component, so that light emitted by the light-emitting component exits after passing through the optical action of the lens 341, so as to adjust the light-emitting state of the illumination module 100.

In addition, the first end 31 is the end with a smaller diameter. The side wall 33 connected to the first end 31 and the connecting wall 112 of the first housing 11 have a receiving space 131 therebetween for accommodating the non-light-emitting component on the outer side of the light-emitting component. That is, the non-light-emitting component (electrical element) on the first power board of the integrated DOB light source component may be mounted in the receiving space 131, so as to reasonably utilize the space of the housing 10 and reduce the size of the illumination module 100.

An edge part extends outward from an end of the second end 32. The edge part is used for being abutted and mounted in a carrying part 122 of the second housing 12.

For quick positioning and snap-fit, the carrying part 122 of the second housing 12 is provided with a first positioning snap-fit part 1223. Correspondingly, the edge part is provided with a second positioning snap-fit part 321. The first positioning snap-fit part 1223 and the second positioning snap-fit part 321 are positioned and connected. Optionally, the first positioning snap-fit part 1223 is a positioning rib disposed on a second extension wall 1221 of the carrying part 122, and the second positioning snap-fit part 321 is a positioning groove formed by inward depression of the edge part.

Further, a snap-fit block extends from the edge part toward the second housing 12. Correspondingly, a carrying wall 1222 of the carrying part 122 is provided with a snap-fit groove. The snap-fit block is snapped in the snap-fit groove.

Please continue to refer to FIGS. 2-7, the first housing 11 and the second housing 12 are positioned and snapped together, and anti-disassembly and light-leakage prevention effects can be achieved after snap-fit.

Specifically, the first housing 11 includes a mounting wall 111 and a connecting wall 112 extending from the mounting wall 111 toward the second housing 12. The connecting wall 112 is provided with at least two first snap-fit parts 1121. The first snap-fit part 1121 is used for snap-fit connection with the second snap-fit part 1231 on the second housing 12, so as to achieve an anti-disassembly effect.

Optionally, in this example, the first snap-fit part 1121 is a snap-fit groove disposed on the connecting wall 112 close to the second housing 12. The snap-fit groove is an annular groove. Certainly, in other examples, the first snap-fit part 1121 may be a snap-fit protrusion 1232, which is not limited herein.

The connecting wall 112 includes an end part close to the second housing 12, and a relief groove 1122 is formed on an inner side of the end part. The relief groove 1122 is used for receiving a lip 124 of the second housing 12, so that the second housing 12 is completely wrapped inside the first housing 11, thereby achieving a light-leakage prevention effect.

Further, because the relief groove 1122 is also annular and disposed below the snap-fit groove, a snap-fit step is formed between the relief groove 1122 and the snap-fit groove. The snap-fit step abuts against an upper surface of the lip 124 of the second housing 12. Because the snap-fit step is located below the snap-fit groove, in response to that the snap-fit step is subjected to an external force, the force application point is not at the first snap-fit part 1121 and the second snap-fit part 1231, so that falling-off of the first housing 11 can be prevented.

The second housing 12 includes a base 121 and a first extension wall 123 extending from the base 121 toward the first housing 11. An inner side of the first extension wall 123 has a light outlet 17. The first extension wall 123 is provided with at least two second snap-fit parts 1231. An outer edge of the first extension wall 123 is provided with a lip 124 extending outward. The first snap-fit part 1121 is snap-connected to the second snap-fit part 1231, and the lip 124 is received in the relief groove 1122 and wrapped by the end part. Through the snap-fit connection of the first snap-fit part 1121 and the second snap-fit part 1231, an anti-disassembly effect of the housing 10 is achieved. At the same time, after the first housing 11 is snap-connected to the second housing 12, the lip 124 of the second housing 12 is received in the relief groove 1122 of the first housing 11 and wrapped inside by the end part of the first housing 11, thereby achieving a light-leakage prevention effect.

In this example, the second snap-fit part 1231 is a snap-fit protrusion 1232 disposed on the first extension wall 123. Certainly, in other examples, the second snap-fit part 1231 may be a snap-fit groove.

Further, the snap-fit protrusion 1232 is an annular inclined snap-fit protrusion 1232. The snap-fit protrusion 1232 includes a snap-fit surface 1234 facing the second housing 12, an inclined guide surface 1233 facing the lip 124, and two inclined end surfaces 1235 connecting the snap-fit surface 1234 and the inclined guide surface 1233. An edge of the snap-fit surface 1234 connecting the two inclined end surfaces 1235 is an arc-shaped edge. That is to say, the snap-fit surface 1234 of the snap-fit protrusion 1232 is an arc-shaped surface, so that it can match the arc-shaped surface of the snap-fit groove. By providing the inclined snap-fit protrusion 1232, the snap-fit area between the snap-fit protrusion 1232 and the snap-fit groove can be increased, thereby achieving the anti-disassembly effect. By providing the inclined guide surface 1233, snap-fit connection between the second housing 12 and the first housing 11 is guided.

Optionally, a plurality of snap-fit protrusions 1232 are provided on the first extension wall 123, and the plurality of snap-fit protrusions 1232 are disposed along a circumferential direction of the first extension wall 123. Two adjacent snap-fit protrusions 1232 are arranged in a mirror-image manner. With such an arrangement, stability of the snap-fit protrusion 1232 with the snap-fit groove can be improved.

The connecting wall 112 is further provided with a force-relieving groove 1236 having the same inclination direction as the snap-fit protrusion 1232. The force-relieving groove 1236 is disposed adjacent to the snap-fit protrusion 1232, and the force-relieving groove 1236 has a pair of inclined surfaces 1237, and the inclined surface 1237 adjacent to the snap-fit protrusion 1232 is connected to the inclined end surface 1235 and located on the same plane with the inclined end surface 1235. By providing the force-relieving groove 1236, a deformation distance of the first extension wall 123 can be reduced.

Further, in order to quickly snap the first housing 11 and the second housing 12 together, a first abutting part 1123 for abutting against the second housing 12 is provided on an inner side of the connecting wall 112. The first extension wall 123 is correspondingly provided with a second abutting part 1238 on a side facing the lip 124, and the second abutting part 1238 is positioned and snapped with the first abutting part 1123.

Optionally, one of the first abutting part 1123 and the second abutting part 1238 is an abutting protrusion, and the other is an abutting groove.

In this example, the first abutting part 1123 is an abutting protrusion protruding from the inner side of the connecting wall 112 into the mounting cavity 13. The abutting protrusion is disconnected at a position of the snap-fit groove, so as to provide space for the snap-fit groove. In addition, a guide surface 1233 is provided on a side of the abutting protrusion facing the second housing 12, so as to facilitate installation.

The second abutting part 1238 is an abutting groove recessed from an outer side of the first extension wall 123 toward the inside. The abutting groove is used for snap-fit positioning with the abutting protrusion.

Further, the abutting protrusion is disposed below the wire-passing groove 114. Therefore, the insulating housing 212 is provided with a relief groove at a position corresponding to the abutting protrusion, and the relief groove is located below the first wire-fixing cavity.

Further, the second housing 12 is further provided with a carrying part 122 for carrying the optical module. The carrying part 122 is formed by recessing from the base 121 in a direction away from the first housing 11, and the carrying part 122 surrounds the light outlet 17.

The carrying part 122 includes a second extension wall 1221 extending in the direction away from the first housing 11 and a carrying wall 1222 extending from the second extension wall 1221 into the light outlet 17. That is, the carrying wall 1222 is located on an inner side of the second extension wall 1221 and is configured to abut against the optical module 30. The carrying wall 1222 is provided with a plurality of reinforcing ribs. A gap is formed between adjacent reinforcing ribs, so as to form a snap-fit groove for snap-fit with the snap-fit block on the second housing 12.

The second extension wall 1221 is provided with a first positioning snap-fit part 1223 for positioning and snapping with the optical module 30. Optionally, the first positioning snap-fit part 1223 is a positioning rib disposed on the second extension wall 1221 of the carrying part 122, and the positioning rib is positioned and snapped with a positioning groove on the optical module 30.

A mounting rotating shaft 125 protruding outward is provided on an outer side of the carrying part 122, and the third housing 14 is correspondingly provided with a rotating shaft groove 141. The mounting rotating shaft 125 is positioned and snapped in the rotating shaft groove 141, so as to achieve snap-fit fixing of the second housing 12 and the third housing 14. At the same time, because the mounting rotating shaft 125 can rotate in the rotating shaft groove 141, the second housing 12 can rotate relative to the third housing 14, so that the light emitting direction of the illumination module 100 can be adjusted.

Further, an inner side of the third housing 14 is configured as a trumpet-shaped light outlet passage, and a small opening is disposed close to the second housing 12 and a large opening is disposed close to a face ring 15. With such an arrangement, a light emitting area is increased.

A notch part is further formed between the third housing 14 and the second housing 12, and the notch part can assist in heat dissipation of the illumination module 100.

Further, a face ring 15 is further provided on a side of the third housing 14 facing away from the second housing 12. The face ring 15 is provided with a torsion spring 16. The illumination module 100 is connected to a mounting base through the torsion spring 16.

Further, in order to improve the heat dissipation effect, a plurality of heat dissipation fins are provided on a side of the first housing 11 facing away from the mounting cavity 13. The housing 10 has a plurality of first housings 11 with the same internal structure but different heights of heat dissipation fins. The different first housings 11 may be replaced according to the power of the light source module 20.

### Example 2

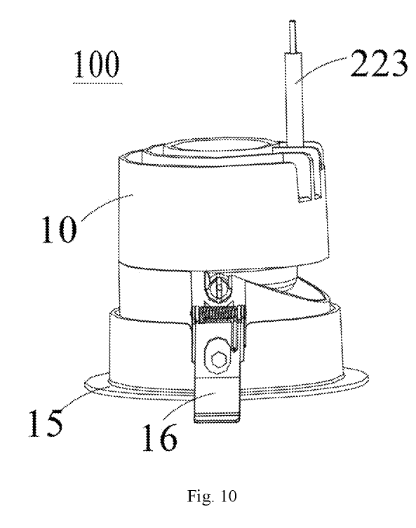

Referring to FIGS. 10-15, an illumination module 100 of a second example of the present disclosure is shown. In this example, the illumination module 100 includes a housing 10, a light source module 20 and an optical module 30. The structure of the housing 10 is the same as the structure of the housing 10 in the first example. The difference lies in that, in this example, the light source module 20 is an external light source module 22, and the external light source module 22 is mounted in the mounting cavity 13 through the second mounting structure on the first housing 11, and the optical module 30 is a micro-prism reflector. In order to avoid repetition, in this example, only the differences are described in detail, and the same parts will not be described herein.

The external light source module 22 includes an external light source assembly 221, a light source bracket 222 and a second power line 223. The external light source assembly 221 is electrically connected to the second power line 223, and is detachably connected to the light source bracket 222.

The light source bracket 222 includes a mounting part 2221 for mounting the external light source assembly 221 and an outer edge part 2222 disposed on an outer edge of the mounting part 2221. The outer edge part 2222 is provided with a second wire-fixing cavity 2223 for the second power line 223 to pass through.

The second mounting structure includes a first fool-proof part 113, a wire-passing groove 114 and a first mounting hole 116. The first fool-proof part 113 and the wire-passing groove 114 are the same structures as the first fool-proof part 113 and the wire-passing groove 114 on the first mounting structure respectively, while the first mounting hole 116 is a structure of the second mounting structure for fixedly connecting with the light source bracket 222.

The outer edge part 2222 of the light source bracket 222 is correspondingly provided with a third fool-proof part 2224, a second wire-fixing cavity 2223 and a second mounting hole 2225. The third fool-proof part 2224 is snapped with the first fool-proof part 113. The position of the second wire-fixing cavity 2223 corresponds to the wire-passing groove 114, and the second wire-fixing cavity 2223 can be snapped into the wire-passing groove 114. The second power line 223 is configured to sequentially pass through the second wire-fixing cavity 2223 and the wire-passing groove 114. A fastener passes through the first mounting hole 116 and the second mounting hole 2225, so as to fixedly connect the light source bracket 222 to the first housing 11.

Because the first fool-proof part 113 is a structure common to the first mounting structure and the second mounting structure, the structure of the second fool-proof part 2123 and the structure of the third fool-proof part 2224, which are connected correspondingly thereto, are the same.

In this example, the first fool-proof part 113 is a clamp groove provided on the mounting wall 111, and the third fool-proof part 2224 is a protrusion provided on the light source bracket 222. Certainly, in other examples, the first fool-proof part 113 may be a protrusion, and the third fool-proof part 2224 may be a clamp groove.

In particular, the fastener is used for fixing the light source bracket 222 and the external light source assembly 221 on the mounting board by passing through the first mounting hole 116 and the second mounting hole 2225. The fastener may be an ST.* self-tapping screw and an M* screw, wherein one ST.* screw and three M* screws are provided. The ST.* screw is an anti-pull screw, so as to enhance the fixing effect with the light source bracket 222.

In this example, the external light source assembly 221 is a non-insulated external light source assembly 221. Therefore, an insulating member 224 is further sandwiched between the non-insulated external light source assembly 221 and the mounting wall 111. Preferably, the insulating member 224 is an insulating and heat-conducting silicone cloth sandwiched between the external light source assembly 221 and the mounting wall 111.

The insulating and heat-conducting silicone cloth is disposed between the external light source assembly 221 and the mounting wall 111 of the first housing 11. The second mounting structure further includes a first positioning member 115 provided on the mounting wall 111 of the first housing 11. The insulating and heat-conducting silicone cloth is correspondingly provided with a second positioning member 225 positioned and connected to the first positioning member 115.

Optionally, the first positioning member 115 is a positioning post, which extends from the mounting wall 111 into the mounting cavity 13. The second positioning member 225 is a positioning hole, which is provided on the insulating and heat-conducting silicone cloth. The positioning post is snapped in the positioning hole, so as to achieve positioning connection between the mounting wall 111 and the insulating and heat-conducting silicone cloth.

Optionally, a plurality of positioning posts may be provided, for example, two positioning posts respectively disposed on two sides of the mounting wall 111 and located at positions different from the first fool-proof part 113 and the wire-passing groove 114. Similarly, a plurality of positioning holes are provided, and the positions of the plurality of positioning holes match the positions of the positioning posts respectively.

Because the insulating member 224 is sandwiched between the external light source assembly 221 (especially the light source bracket 222) and the mounting wall 111, the light source bracket 222 is provided with a mounting structure for fixedly connecting to the mounting wall 111. The mounting structure includes a third fool-proof part 2224, the second wire-fixing cavity 2223 and a second mounting hole 2225. The third fool-proof part 2224 is configured to be snapped with the first fool-proof part 113 on the mounting wall 111. The second wire-fixing cavity 2223 is configured to be snapped with the wire-passing groove 114 on the mounting wall 111. The second mounting hole 2225 is configured to be snapped with the first mounting hole 116 on the mounting wall 111.

The insulating member 224 is provided with a relief structure at a position corresponding to the mounting structure. The insulating member 224 is further provided with a relief hole 2241 for providing space for the first mounting hole 116 and a relief groove 2242 for providing space for the wire-passing groove 114.

The light source bracket 222 is provided with a mounting structure for fixedly connecting to the mounting wall 111. The insulating member 224 is provided with a relief structure at a position corresponding to the mounting structure. The relief structure includes a relief hole 2241, a relief groove 2242 and a relief notch 2243. The relief hole 2241 is provided corresponding to the first mounting hole 116. The relief groove 2242 is provided corresponding to the second wire-fixing cavity 2223. The relief notch 2243 is provided corresponding to the third fool-proof part 2224.

Optionally, in this example, the optical module 30 is a micro-prism reflector 35.

The micro-prism reflector 35 includes a first end 31, a second end 32, and a side wall 33 connecting the first end 31 and the second end 32. The diameter of the first end 31 is smaller than the diameter of the second end 32. The side wall 33 is provided with a plurality of micro-prism structures.

The first end 31 is provided with an abutting part extending toward the external light source assembly 221. Four abutting parts abut against the outer side of the light-emitting component of the external light source assembly 221, so that the first end 31 covers the outer side of the light-emitting component, and light emitted by the light-emitting component exits after the optical action of the micro-prism reflector 35, so as to adjust the light-emitting state of the illumination module 100.

The end of the second end 32 extends outward to form an edge part. The edge part is used for being abutted and mounted in a carrying part 122 of the second housing 12. A snap-fit block is provided, which extends from the edge part toward the second housing 12. Correspondingly, a carrying wall 1222 of the carrying part 122 is provided with a snap-fit groove, the snap-fit block is snapped in the snap-fit groove.

For quick positioning and snap-fit, the carrying part 122 of the second housing 12 is provided with a first positioning snap-fit part 1223. Correspondingly, the edge part is provided with a second positioning snap-fit part 321. The first positioning snap-fit part 1223 and the second positioning snap-fit part 321 are positioned and connected. Optionally, the first positioning snap-fit part 1223 is a positioning rib disposed on a second extension wall 1221 of the carrying part 122, and the second positioning snap-fit part 321 is a positioning groove formed by inward depression of the edge part.

### Example 3

A illumination module 100 of a third example of the present disclosure includes a housing 10, a light source module 20 and an optical module 30. The structure of the housing 10 is the same as the structure of the housing 10 in the second example. The difference lies in that, in this example, the light source module 20 is an insulated external light source module 22, and the optical module 30 is a lens assembly 34. However, the structure of the lens assembly 34 is the same as the structure of the lens assembly 34 in the first example. In order to avoid repetition, in this example, only the differences are described in detail, and the same parts will not be described herein.

Because in this example, the light source module 20 is an insulated external light source module 22, the insulated external light source module 22 is directly mounted on the mounting wall 111 through the second mounting structure on the first housing 11.

The insulated external light source module 22 includes a light source bracket 222 and an insulated external light source assembly 221. The light source bracket 222 and the insulated external light source assembly 221 are same structures as those in the second example, which will not be described herein.

In this example, the first positioning member 115 may not be provided on the mounting wall 111. In other words, the first positioning member 115 is located in a gap of the insulated external light source assembly 221 and does not affect the mounting of the external light source assembly 221, that is, it does not function in the mounting of the external light source assembly 221.

The insulated external light source assembly 221 directly abuts against the mounting wall 111. The mounting wall 111 is provided with a first fool-proof part 113. The insulated external light source module 22 is correspondingly provided with a third fool-proof part 2224. The third fool-proof part 2224 is positioned and snapped with the first fool-proof part 113. The structure of the first fool-proof part 113 and the structure of the third fool-proof part 2224 are the same as those in the second example, which will not be described herein.

### Example 4

A illumination module 100 of a fourth example of the present disclosure includes a housing 10, a light source module 20 and an optical module 30. The housing 10 and the light source module 20 are respectively the same as the housing 10 and the light source module 20 in the first example. The difference lies in that, in this example, the optical module 30 is a micro-prism reflector 35. However, the structure of the micro-prism reflector 35 is the same as the structure of the micro-prism reflector 35 in the second example. In order to avoid repetition, it will not be described herein.

### Example 5

A illumination module 100 of a fifth example of the present disclosure includes a housing 10, a light source module 20 and an optical module 30. The housing 10 and the light source module 20 are respectively the same as the housing 10 and the light source module 20 in the second example. The difference lies in that, in this example, the optical module 30 is a lens assembly 34. However, the structure of the lens assembly 34 is the same as the structure of the lens assembly 34 in the first example. In order to avoid repetition, it will not be described herein.

An objective of the present disclosure is to provide an illumination module which is capable of preventing a first power line from being damaged during installation, thereby improving service life.

To achieve the above objective, the present disclosure provides an illumination module, including:
a housing, including a first housing and a second housing snapped together, wherein a mounting cavity is provided between the first housing and the second housing, the first housing has a mounting wall facing the second housing, and the mounting wall is provided with a wire-passing groove; and
a light source module, disposed in the mounting cavity, including a built-in light source assembly, an insulating housing, and a first power line, wherein the built-in light source assembly is electrically connected to the first power line, the insulating housing is disposed between the built-in light source assembly and the first housing and includes an accommodating groove for accommodating the built-in light source assembly and a first wire-fixing cavity extending toward the first housing, the first wire-fixing cavity is receivable in the wire-passing groove, and the first power line is at least partially received in the first wire-fixing cavity and snapped with the first wire-fixing cavity, and is capable of sequentially passing through the first wire-fixing cavity and the wire-passing groove.

Optionally, the insulating housing includes a top wall facing the mounting wall and a peripheral wall extending from the top wall in a direction away from the mounting wall, and an accommodating groove for accommodating the built-in light source assembly is formed between the top wall and the peripheral wall.

Optionally, the mounting wall is provided with a first fool-proof part, and a side of the top wall facing away from the accommodating groove is provided with a second fool-proof part snapped with the first fool-proof part.

Optionally, one of the first fool-proof part and the second fool-proof part is a clamp groove, and the other is a protrusion.

Optionally, the mounting wall is provided with a first positioning member, the top wall is correspondingly provided with a second positioning member, and the first positioning member and the second positioning member are positioned and snapped together.

Optionally, one of the first positioning member and the second positioning member is a positioning post, and the other is a positioning hole.

Optionally, the mounting wall is further provided with a first mounting hole, and the first mounting hole is configured for a fastener to pass through so as to fix an external light source assembly in the mounting cavity.

Optionally, the illumination module further includes an optical module, and two ends of the optical module respectively abut against the light source module and the second housing; the optical module is a micro-prism reflector, or the optical module is a lens assembly.

Optionally, the second housing includes a base, a first extension wall extending from the base toward the first housing, and a second extension wall extending from the base in a direction away from the first housing, an inner side of the first extension wall is provided with a light outlet, the second extension wall surrounds the light outlet, and the second extension wall is provided with a first positioning snap-fit part for positioning and snapping with the optical module, and the optical module is correspondingly provided with a second positioning snap-fit part.

Optionally, the housing further includes a third housing, the third housing is disposed on a side of the second housing facing away from the first housing, the second housing is provided with a mounting rotating shaft, and the third housing is correspondingly provided with a rotating shaft groove.

The beneficial effects of the present disclosure are as follows: in the illumination module of the present disclosure, by disposing the insulating housing between the built-in light source assembly and the first housing, safety of the illumination module is improved. By providing the first wire-fixing cavity on the insulating housing, the first power line is at least partially received in the first wire-fixing cavity and snapped with the first wire-fixing cavity, and then the entire first wire-fixing cavity is received in the wire-passing groove, so as to fix the first power line and provide double protection, thereby preventing the first power line from being pulled and damaged, and improving the service life of the illumination module.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical solutions of the present disclosure and not to limit the same. Although the present disclosure has been described in detail with reference to examples, those of ordinary skill in the art should understand that they may modify the technical solutions of the present disclosure or make equivalent replacements to some or all of the technical solutions thereof, without departing from the spirit and scope of the technical solutions of the present disclosure.

1. A illumination module, comprising:
a housing, comprising a first housing and a second housing snapped together, wherein a mounting cavity is provided between the first housing and the second housing, the first housing has a mounting wall facing the second housing, and the mounting wall is provided with a wire-passing groove; and
a light source module, disposed in the mounting cavity, comprising a built-in light source assembly, an insulating housing and a first power line, wherein the built-in light source assembly is electrically connected to the first power line, the insulating housing is disposed between the built-in light source assembly and the first housing and comprises an accommodating groove for accommodating the built-in light source assembly and a first wire-fixing cavity extending toward the first housing, the first wire-fixing cavity is receivable in the wire-passing groove, and the first power line is at least partially received in the first wire-fixing cavity and snapped with the first wire-fixing cavity, and is capable of sequentially passing through the first wire-fixing cavity and the wire-passing groove.

2. The illumination module according to claim 1, wherein the insulating housing comprises a top wall facing the mounting wall and a peripheral wall extending from the top wall in a direction away from the mounting wall, and the accommodating groove configured to accommodate the built-in light source assembly is formed between the top wall and the peripheral wall.

3. The illumination module according to claim 2, wherein the mounting wall is provided with a first fool-proof part, and a side of the top wall facing away from the accommodating groove is provided with a second fool-proof part positioned and snapped with the first fool-proof part.

4. The illumination module according to claim 3, wherein one of the first fool-proof part and the second fool-proof part is a clamp groove , and the other is a protrusion.

5. The illumination module according to claim 2, wherein the mounting wall is provided with a first positioning member, the top wall is correspondingly provided with a second positioning member, and the first positioning member and the second positioning member are positioned and snapped together.

6. The illumination module according to claim 5, wherein one of the first positioning member and the second positioning member is a positioning post, and the other is a positioning hole.

7. The illumination module according to claim 1, wherein the mounting wall is further provided with a first mounting hole, and the first mounting hole is configured for a fastener to pass through so as to fix an external light source assembly in the mounting cavity.

8. The illumination module according to claim 1, further comprising an optical module, wherein two ends of the optical module respectively abut against the light source module and the second housing; the optical module comprises a micro-prism reflector, or the optical module is a lens assembly.

9. The illumination module according to claim 8, wherein the second housing comprises a base, a first extension wall extending from the base toward the first housing, and a second extension wall extending from the base in a direction away from the first housing, an inner side of the first extension wall is provided with a light outlet, the second extension wall surrounds the light outlet, and the second extension wall is provided with a first positioning snap-fit part for positioning and snapping with the optical module, and the optical module is correspondingly provided with a second positioning snap-fit part.

10. The illumination module according to claim 1, wherein the housing further comprises a third housing, the third housing is disposed on a side of the second housing facing away from the first housing, the second housing is provided with a mounting rotating shaft, and the third housing is correspondingly provided with a rotating shaft groove.

11. The illumination module according to claim 1, wherein the housing further comprises a first mounting structure configured to mount the built-in light source assembly and a second mounting structure configured to mount an external light source assembly.

12. The illumination module according to claim 1, wherein the wire-passing groove includes a first opening facing the mounting cavity and a second opening facing away from the mounting cavity, the first opening having a greater area than the second opening.
